(19) United States
(12) Patent Application Publication
(10) Pub. No.: US 2020/0271843 A1
(43) Pub. Date: Aug. 27, 2020

(54) QUARTER WAVE PLATE HAVING META-PATTERNS, METHOD OF MANUFACTURING THE QUARTER WAVE PLATE, AND DETECTION APPARATUS HAVING THE QUARTER WAVE PLATE

(71) Applicants: SAMSUNG ELECTRONICS CO., LTD., Suwon-si (KR); INDUSTRY-ACADEMIC COOPERATION FOUNDATION, YONSEI UNIVERSITY, Seoul (KR)

(72) Inventors: Unjeong KIM, Osan-si (KR); Yeonsang Park, Seoul (KR); Seungwan Cho, Seoul (KR); Hyunyong Choi, Seoul (KR); Younggeun Roh, Seoul (KR); Chihun In, Seoul (KR)

(73) Assignees: SAMSUNG ELECTRONICS CO., LTD., Suwon-si (KR); INDUSTRY-ACADEMIC COOPERATION FOUNDATION, YONSEI UNIVERSITY, Seoul (KR)

(21) Appl. No.: 16/676,027

(22) Filed: Nov. 6, 2019

(30) Foreign Application Priority Data
Feb. 25, 2019 (KR) 10-2019-0021952

(51) Int. Cl. G02B 5/30; G02F 1/01

(52) U.S. Cl. CPC G02B 5/3083; G02F 2001/133541; G02F 1/01

(57) ABSTRACT

Provided are a quarter wave plate, a method of manufacturing the quarter wave plate, and a detection apparatus including the quarter wave plate. The quarter wave plate includes a transparent substrate, and a plurality of meta-patterns provided on the transparent substrate, wherein the plurality of meta-patterns are configured to convert linearly polarized light incident thereon into circularly polarized light.

### CROSS-REFERENCE TO RELATED APPLICATION

This application claims priority from Korean Patent Application No. 10-2019-0021952, filed on Feb. 25, 2019 in the Korean Intellectual Property Office, the disclosure of which is incorporated herein in its entirety by reference.

### BACKGROUND

### 1. Field

Example embodiments of the present disclosure relate to optical wave plates and detection apparatuses including the optical wave plates, and more particularly, to quarter wave plates, methods of manufacturing the quarter wave plates, and detection apparatuses including the quarter wave plates.

### 2. Description of the Related Art

In Raman spectroscopy, a spectrum unique to a material is generated. Accordingly, Raman spectroscopy has advantages in material sensing and quantification. However, in Raman spectroscopy, the spectrum generation efficiency is low and detection signals may be weak because a material to be detected may be present in a trace amount. In order to solve these problems, a technique that is referred to as a surface enhanced Raman spectroscopy (SERS) may be used. This technique is used to amplify a Raman spectrum, and thus, has become a powerful means of analyzing a material with high sensitivity. SERS generally uses a localized surface plasmon phenomenon in which an electric field is focused on a metal nano-structure, and it is known that SERS may theoretically amplify Raman signals from about 106 times to about 1014 times.

Biomaterials may absorb infrared rays in a mid-infrared (mid-IR) region due to a vibrational mode of molecules. When the biomaterial has chirality, the biomaterial shows an absorbance difference of infrared ray with respect to right-circular polarization (RCP) light and left-circular polarization (LCP) light. As a method of measuring this absorbance difference, a vibrational circular dichroism (VCD) method may be used.

Raman spectroscopy is another method using the vibrational mode and mainly uses visible light as a light source, and thus, Raman spectroscopy may be affected by fluorescence of other light sources. However, since the VCD method uses mid-IR light as a light source, no fluorescence effect occurs. Also, when the VCD method is used, only materials having chirality may be selectively detected in an IR absorption method of the related art, and thus, more accurate material detection is possible.

Raman scattering is generated by the vibrational mode of molecules. In Raman scattering, when the molecules have chirality, the intensity of a Raman signal changes with the circular polarization direction of incident light. As method of measuring the intensity difference, a Raman optical activity (ROA) method may be used.

In order to use the ROA method and the VCD method, linearly polarized light should be converted to LCP light or RCP light. To convert light, a quarter wave plate (QWP) is used. Most of currently used QWPs use Fresnel rhombs and quarter-wave retarders.

### SUMMARY

One or more example embodiments provide quarter wave plates including meta-patterns that enable miniaturization of a detection apparatus.

One or more example embodiments also provide quarter wave plates including meta-patterns that have flexibility and expand a detection region due to the flexibility.

One or more example embodiments also provide quarter wave plates including meta-patterns that amplify a minute detection signal.

One or more example embodiments also provide methods of manufacturing the quarter wave plates.

One or more example embodiments also provide detection apparatuses including the quarter wave plates.

Additional aspects will be set forth in part in the description which follows and, in part, will be apparent from the description, or may be learned by practice of example embodiments.

According to an aspect of an example embodiment, there is provided a quarter wave plate including a transparent substrate, and a plurality of meta-patterns provided on the transparent substrate, wherein the plurality of meta-patterns are configured to convert linearly polarized light incident thereon into circularly polarized light.

The transparent substrate may be flexible.

The transparent substrate may be inflexible.

The plurality of meta-patterns may include horizontally and vertically repeating unit meta-patterns.

The transparent substrate may include horizontally and vertically repeating unit regions, and two meta-patterns that are different from each other are included in each of the unit regions.

The plurality of meta-patterns may be coated with a protection film.

Each of the unit meta-patterns may include a first meta-pattern, and a second meta-pattern that is perpendicular to and separated from the first meta-pattern.

The first meta-pattern and the second meta-pattern may be embossed.

A meta-material layer may be provided on the transparent substrate, and the first meta-pattern and the second meta-pattern may be provided as a first hole and a second hole, respectively, that are formed in the meta-material layer.

A wavelength band of the linearly polarized light may include light in a range from visible light to near infrared band light.

A wavelength band of the linearly polarized light may include an infrared band light.

The protection film may include an oxide or a nitride.

According to another aspect of an example embodiment, there is provided a detection apparatus including a light source configured to emit linearly polarized light, a quarter meta-wavelength plate configured to convert the linearly polarized light emitted from the light source and incident thereon into circularly polarized light emitted toward an object, and a detector configured to detect light incident on the detector from the object that is irradiated with the circularly polarized light from the quarter meta-wavelength plate.

The light source may include a light emitter configured to emit unpolarized light, and a polarizer configured to convert the unpolarized light into linearly polarized light.

The quarter meta-wavelength plate may be flexible.

The light emitted from the object may pass the quarter meta-wavelength plate.

The light emitted from the object may not pass the quarter meta-wavelength plate.

The quarter meta-wavelength plate may include a first meta-pattern, and a second meta-pattern that is perpendicular to and separated from the first meta-pattern, wherein the first meta-pattern and the second meta-pattern directly contact the object.

The quarter meta-wavelength plate may be a single-use wavelength plate.

The first meta-pattern and the second meta-pattern may be coated with a protection film.

### BRIEF DESCRIPTION OF THE DRAWINGS

The above and/or other aspects will become apparent and more readily appreciated from the following description of example embodiments, taken in conjunction with the accompanying drawings in which:

FIG. 1 is a perspective view of a quarter wave plate (QWP) including meta-patterns according to an example embodiment;

FIG. 2 is a plan view of a unit cell of FIG. 1;

FIG. 3 is a cross-sectional view taken along line 3-3′ of FIG. 2;

FIG. 4 is a perspective view of a QWP including meta-patterns according to another example embodiment;

FIG. 5 is a plan view of a unit cell of FIG. 4;

FIG. 6 is a cross-sectional view taken along line 6-6′ of FIG. 5;

FIG. 7 is a graph showing a result of a first simulation performed to confirm the transmittance of a QWP including meta-patterns according to an example embodiment in a near infrared band;

FIG. 8 is a graph showing a result of a second simulation performed to confirm a phase retardation of a QWP including meta-patterns according to an example embodiment in a near infrared band;

FIG. 9 is a graph showing a result of a third simulation performed to confirm the transmittance of a QWP including meta-patterns according to an example embodiment in a near infrared band;

FIG. 10 is a graph showing a result of a fourth simulation performed to confirm a phase retardation of a QWP including meta-patterns according to an example embodiment in a near infrared band;

FIG. 11 is a graph showing a result of a fifth simulation performed to confirm the transmittance of a QWP including meta-patterns according to another example embodiment in a near infrared band;

FIG. 12 is a graph showing a result of a sixth simulation performed to confirm a phase retardation of a QWP including meta-patterns according to another example embodiment in a near infrared band;

FIG. 13 is a graph showing a result of a seventh simulation performed to confirm the transmittance of a QWP including meta-patterns according to another example embodiment in a near infrared band;

FIG. 14 is a graph showing a result of an eighth simulation performed to confirm a phase retardation of a QWP including meta-patterns according to an example embodiment in a near infrared band;

FIG. 15 is a graph showing a result of a ninth simulation performed to confirm the transmittance of a QWP including meta-patterns according to another example embodiment in a mid-infrared (mid-IR) band;

FIG. 16 is a graph showing a result of a tenth simulation performed to confirm a phase retardation of a QWP including meta-patterns according to another example embodiment in a mid-IR band;

FIG. 17 is a graph showing a result of an eleventh simulation performed to confirm the transmittance of a QWP including meta-patterns according to another example embodiment in a mid-IR band;

FIG. 18 is a graph showing a result of a twelfth simulation performed to confirm a phase retardation of a QWP including meta-patterns according to another embodiment in a mid-IR band;

FIG. 19 is a graph showing a result of a thirteenth simulation performed to confirm the transmittance of a QWP including meta-patterns according to another example embodiment in a mid-IR band;

FIG. 20 is a graph showing a result of a fourteenth simulation performed to confirm a phase retardation of a QWP including meta-patterns according to another example embodiment in a mid-IR band;

FIG. 21 is a graph showing a result of a fifteenth simulation performed to confirm the transmittance of a QWP including meta-patterns according to another example embodiment in a mid-IR band;

FIG. 22 is a graph showing a result of a sixteenth simulation performed to confirm a phase retardation of a QWP including meta-patterns according to another example embodiment in a mid-IR band;

FIGS. 23 through 26 are cross-sectional views or plan views showing the operations of a method of manufacturing a QWP including meta-patterns according to an example embodiment;

FIGS. 27 through 30 are cross-sectional views or plan views showing the operations of a method of manufacturing a QWP including meta-patterns according to another example embodiment;

FIGS. 31 through 36 are cross-sectional views of detection apparatuses including a QWP including meta-patterns according to example embodiments; and

FIG. 37 is a cross-sectional view showing a case in which light incident to an object through a circular polarizer is emitted to a detector without passing through the circular polarizer in detection apparatuses according to the example embodiments.

### DETAILED DESCRIPTION

The example embodiments are described in detail with reference to the accompanying drawings. However, the present disclosure is not limited thereto and it will be understood that various changes in form and details may be made therein without departing from the spirit and scope of the following claims. That is, descriptions on particular structures or functions may be presented merely for explaining example embodiments.

While such terms as “first,” “second,” etc., may be used to describe various components, such components must not be limited to the above terms. The above terms are used only to distinguish one component from another.

The terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Most of the currently used QWPs may use Fresnel rhombs or quarter-wave retarders. The method of using the Fresnel rhombs uses a phenomenon that a phase difference between S-polarization light and P-polarization light is generated when a total internal reflection occurs. The method of using the Fresnel rhombs has an advantage of showing a constant retardation in a wide wavelength range, but has a drawback in that the volume of the device is a relatively large since it has to generate the total internal reflection twice. The method of using the quarter-wave retarders uses a birefringence of a material. Therefore, the volume of the device may be reduced less than the device used for the method of using the Fresnel rhombs. However, the wavelength dependence of retardation is large. Accordingly, the method of using the quarter-wave retarders may perform the role of a QWP in a limited wavelength and using the quarter-wave retarders in a wide wavelength range to which the VCD method is applied may be limited.

Therefore, according to an example embodiment, QWPs may have a relatively small volume than a conventional QWP and may be applied to detection apparatuses for detecting biomaterials using an ROA method and a VCD method. The QWPs according to an example embodiment may obtain an effect of a surface enhanced Raman spectroscopy (SERS) based on a nano-structured meta-pattern, and thus, the QWPs may sufficiently detect a very small amount of material having chirality.

Hereinafter, QWPs including meta-patterns according to example embodiments, a method of manufacturing the QWPs including meta-patterns, and detection apparatuses including the QWPs will be described with reference to the accompanying drawings. In the drawings, thicknesses of layers or regions may be exaggerated for clarity of the specification.

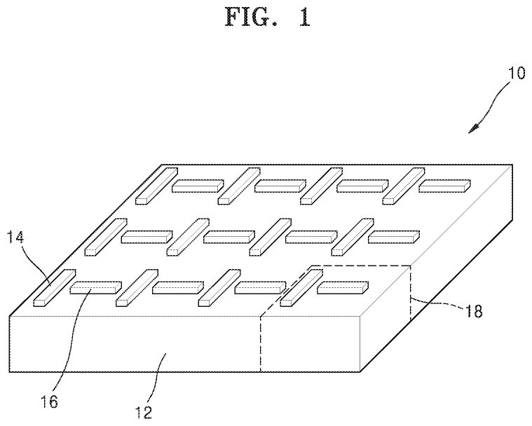

FIG. 1 is a perspective view of a quarter wave plate (QWP) 10 including a meta-pattern according to an example embodiment.

Referring to FIG. 1, the first QWP 10 including meta-patterns includes a substrate 12, and a plurality of meta-patterns 14 and 16 arranged on the substrate 12. The plurality of meta-patterns 14 and 16 may be embossed patterns. Each of the plurality of meta-patterns 14 and 16 may have a dimension less than a wavelength of incident light. As an example, the dimension of each of the plurality of meta-patterns 14 and 16 may be a half of or less than a wavelength of incident light. The substrate 12 may be a flexible substrate that is transparent with respect to light. Accordingly, the substrate 12 may be bent and may be attached to flat and curved surfaces of various shapes. The substrate 12 may include polydimethylsiloxane (PDMS), polyimide, or a printed circuit board (PCB), but is not limited thereto.

In another example embodiment, the substrate 12 may be a substrate that is transparent with respect to light and is inflexible. In this case, the substrate 12 may include a material, for example, quartz or glass, but is not limited thereto.

The plurality of meta-patterns 14 and 16 may include a metal that may be used in plasmonics. As an example, a material of the plurality of meta-patterns 14 and 16 may be gold (Au), silver (Ag), aluminum (Al), or copper (Cu), but is not limited thereto. The plurality of meta-patterns 14 and 16 include a plurality of first meta-patterns 14 and a plurality of second meta-patterns 16. The first QWP 10 includes a plurality of unit regions 18. The first QWP 10 may be divided into the plurality of unit regions 18. Each of the plurality of unit regions 18 may be a unit cell.

The entire substrate 12 may include a single material, and may be a monolayer in which there is no a physical layer boundary or a regional boundary. Accordingly, the boundary (dotted line) of each of the unit regions 18 shown in FIG. 1 is just an imaginary line for convenience of explanation.

Each of the unit regions 18 may be a region that includes only two meta-patterns, that is, a first meta-pattern 14 and a second meta-pattern 16. Accordingly, a combination of the first meta-pattern 14 and the second meta-pattern 16 may be a unit meta-pattern. This method of division may be applied to QWPs according to example embodiments which will be described below. In the first QWP 10, the plurality of unit regions 18 may be regularly arranged. For example, the plurality of unit regions 18 may be arranged in a lattice type. Accordingly, the plurality of unit meta-patterns may be regularly arranged on the substrate 12.

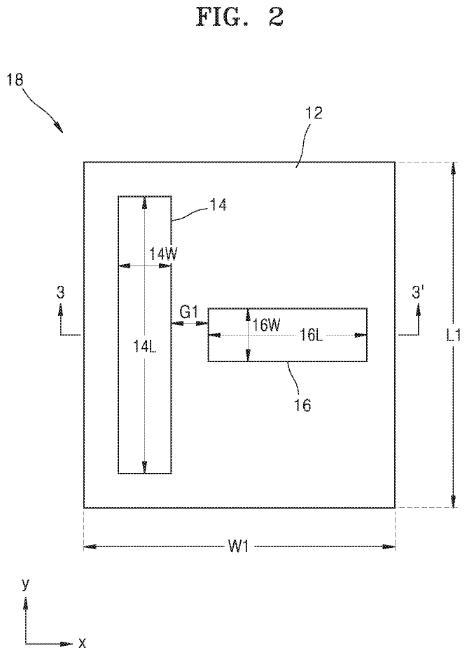

The arrangement directions of the first meta-pattern 14 and the second meta-pattern 16 may be different from each other. As an example, as depicted in FIG. 2, the first meta-pattern 14 and the second meta-pattern 16 may be perpendicularly arranged to each other. FIG. 2 is a plan view of the unit region 18 of FIG. 1.

Referring to FIG. 2, the unit region 18 has a first length L1 in a y-axis direction and a first width W1 in an x-axis direction. The first meta-pattern 14 has a length 14L less than the first length L1 in the y-axis direction and has a width 14W less than the first width W1 in the x-axis direction. The length 14L of the first meta-pattern 14 is greater than the width 14W of the first meta-pattern 14. The second meta-pattern 16 is separated from the first meta-pattern 14 in the x-axis direction by a first distance G1. The second meta-pattern 16 has a length 16L less than the first width W1 in the x-axis direction. The second meta-pattern 16 has a width 16W less than the first length L1 in the y-axis direction. The length 16L of the second meta-pattern 16 is less than the length 14L of the first meta-pattern 14 and is greater than the width 14W of the first meta-pattern 14. The width 16W of the second meta-pattern 16 and the width 14W of the first meta-pattern 14 may be equal to each other or different from each other. The first meta-pattern 14 and the second meta-pattern 16 are separated from the boundary of the unit region 18. The second meta-pattern 16 is arranged between the first meta-pattern 14 and a right-side boundary of the unit region 18. The first meta-pattern 14 has the length 14L in the y-axis direction and the second meta-pattern 16 has the length 16L in the x-axis direction. Accordingly, the second meta-pattern 16 is perpendicularly arranged to the first meta-pattern 14 in the x-axis direction. The second meta-pattern 16 may be arranged in the center of the unit region 18 in the y-axis direction. The first meta-pattern 14 may be arranged between the second meta-pattern 16 and a left-side boundary of the unit region 18.

The dimension of each of the first meta-pattern 14 and the second meta-patterns 16 and the dimensions related to the mutual arrangement thereof may be changed according to a measurement method or a detection method of a measuring apparatus or a detection apparatus to which the first QWP 10 is applied. For example, in the case when a detection apparatus to which the first QWP 10 is applied is used to detect a biomaterial by using an ROA method and in the case when a detection apparatus to which the first QWP 10 is applied is used to detect a biomaterial by using a VCD method, the dimensions of the first and second meta-patterns 14 and 16 and the dimensions related to the mutual arrangement thereof may be changed. Also, when a detection apparatus to which the first QWP 10 is applied is used to detect a biomaterial by using the same method, the dimensions of the unit region 18 and the gap G1 between the first meta-pattern 14 and the second meta-pattern 16 may be changed according to a height variation of the first meta-pattern 14 and the second meta-pattern 16. The first meta-pattern 14 and the second meta-pattern 16 may be arranged to change linearly polarized light into circularly polarized light. Accordingly, the first QWP 10 including the first meta-pattern 14 and the second meta-pattern 16 may be referred to as a quarter meta-wave plate or a meta-quarter wave plate (meta-QWP).

Examples of the changes of the dimensions of the unit region 18 and the dimensions of the first meta-pattern 14 and the second meta-pattern 16 will be described in the explanation of simulations with respect to the first QWP 10.

The cases of changing the dimensions of the unit region 18 and the dimensions of the first meta-pattern 14 and the second meta-patterns 16 may be equally applied to QWPs according to other embodiments which will be described below.

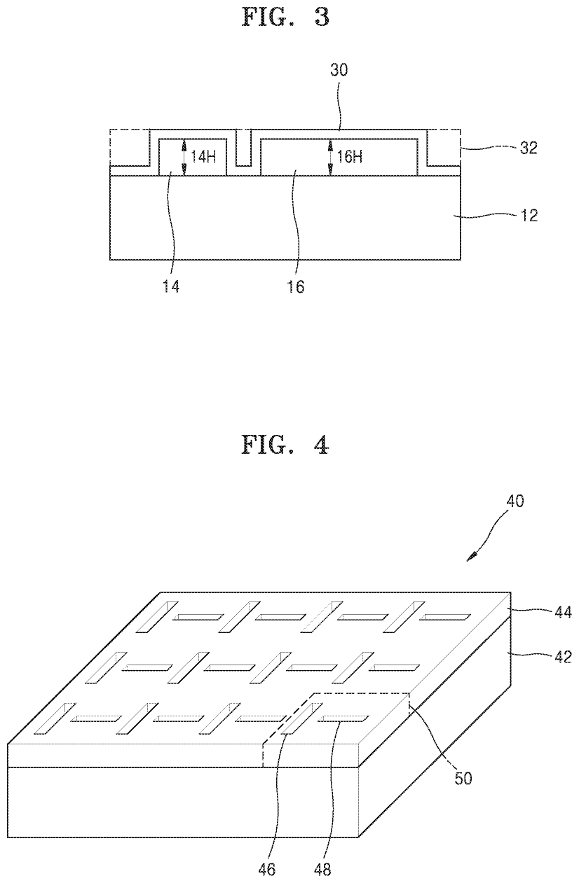

FIG. 3 is a cross-sectional view taken along line 3-3′ of FIG. 2.

Referring to FIG. 3, the first meta-pattern 14 has a first height 14H and the second meta-pattern 16 has a second height 16H. The first meta-pattern 14 and the second meta-patterns 16 may be simultaneously formed by using the same material, and thus, the first height 14H and the second height 16H may be equal. The dimensions of the first meta-pattern 14 and the second meta-patterns 16 may be changed according to the first height 14H and the second height 16H of the first meta-pattern 14 and the second meta-patterns 16. As an example, a range of the first height 14H and the second height 16H of the first meta-pattern 14 and the second meta-patterns 16 may be in a range from about 60 nm to about 100 nm. However, the range may be changed according to light used for detection. The first meta-pattern 14 and the second meta-patterns 16 may be covered by a protection film 30. The protection film 30 may be formed on the substrate 12 and may extend along surfaces of the first meta-pattern 14 and the second meta-patterns 16. Accordingly, a surface shape or a curve of the protection film 30 may be similar to the surface shape or the curve of the substrate 12 on which the first meta-pattern 14 and the second meta-patterns 16 are arranged. The protection film 30 may be a material film transparent with respect to light. As an example, the protection film 30 may include an oxide or a nitride, but is not limited thereto. The protection film 30 may be formed to have a thickness less than the first height 14H and the second height 16H of the first meta-pattern 14 and the second meta-patterns 16. As an example, the protection film 30 may have a thickness of 20 nm or less, but is not limited thereto.

The protection film 30 may cover the first meta-pattern 14 and the second meta-patterns 16 as an imaginary protection line 32 indicated by a dashed line, and a surface of the protection film 30 may be flat.

FIG. 4 is a perspective view of a QWP 40 including meta-patterns according to another example embodiment.

Referring to FIG. 4, the second QWP 40 including meta-patterns includes a substrate 42 and a meta-material layer 44 on the substrate 42. The substrate 42 may be materially the same as the substrate 12 of the first QWP 10. The meta-material layer 44 may be a material layer including the same material as the first meta-pattern 14 and the second meta-patterns 16 of the first QWP 10. The meta-material layer 44 includes a plurality of unit regions 50. The plurality of unit regions 50 may not be physically divided regions. The unit region 50 may include a region of the substrate 42. The unit region 50 may include only a first meta-pattern 46 and a second meta-pattern 48. The first meta-pattern 46 may be a through hole having a dimension less than a wavelength of incident light. The second meta-pattern 48 may also be a through hole having a dimension less than a wavelength of incident light. The first meta-pattern 46 and the second meta-patterns 48 of the second QWP 40 may be patterns engraved in the meta-material layer 44. The shape and the mutual arrangement relationship between each of the first meta-pattern 46 and the second meta-patterns 48 may correspond to the shape and the mutual arrangement relationship between each of the first meta-pattern 14 and the second meta-patterns 16 of the first QWP 10. However, this does not necessarily denote that the dimension of each of the first meta-pattern 46 and the second meta-patterns 48 and the dimensions related to the mutual arrangement thereof are equal to the dimension of each of the first meta-pattern 14 and the second meta-patterns 16 and the dimensions related to the mutual arrangement thereof of the first QWP 10.

Likewise the first meta-pattern 14 and the second meta-patterns 16 of the first QWP 10, the first meta-pattern 46 and the second meta-patterns 48 are also arranged to convert linearly polarized light into circularly polarized light. Accordingly, the second QWP 40 including the first meta-pattern 46 and the second meta-patterns 48 may also be the quarter meta-wave plate or the meta-QWP.

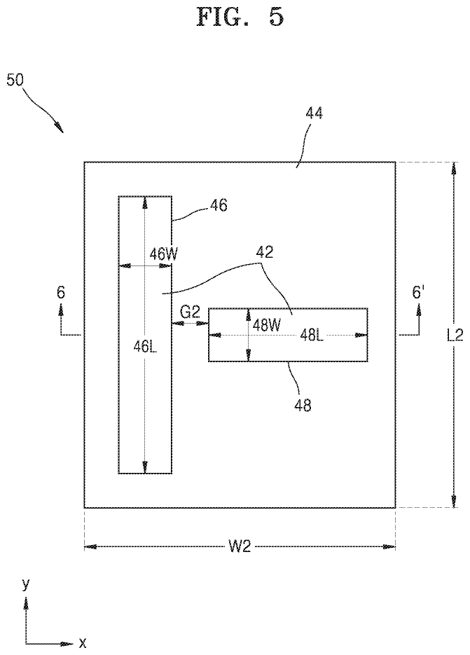

FIG. 5 is a plan view of the unit region 50 of the second QWP 40 of FIG. 4.

Referring to FIG. 5, the unit region 50 is a region having a second length L2 in a y-axis direction and a second width W2 in an x-axis direction. The first meta-pattern 46 has a length 46L less than the second length L2 in the y-axis direction. The first meta-pattern 46 has a width 46W less than the second width W2 in the x-axis direction.

In the y-axis direction, gaps between both edges of the first meta-pattern 46 and boundaries of the unit region 50 adjacent to the first meta-pattern 46 may be equal to each other. That is, the first meta-pattern 46 may be constantly separated from the upper and lower boundaries of the unit region 50. The first meta-pattern 46 is arranged between a left-boundary of the unit region 50 and the second meta-pattern 48. The second meta-pattern 48 is separated from the first meta-pattern 46 in the x-axis direction by a second distance G2. The second meta-pattern 48 is formed perpendicular to the first meta-pattern 46 in the x-axis direction. The second meta-pattern 48 is arranged between a right-boundary of the unit region 50 and the first meta-pattern 46. The second meta-pattern 48 has a length 48L less than the second width W2 in the x-axis direction. The second meta-pattern 48 has a width 48W less than the second length L2 in the y-axis direction. The length 48L of the second meta-pattern 48 in the x-axis direction is less than the length 46L of the first meta-pattern 46 in the y-axis direction. The width 48W of the second meta-pattern 48 in the y-axis direction and the width 46W of the first meta-pattern 46 in the x-axis direction may be equal to each other or different from each other. The second gap G2 may be less than the width 46W of the first meta-pattern 46 and the width 48W of the second meta-patterns 48 like the first gap G1 of the first QWP 10.

FIG. 6 is a cross-sectional view taken along line 6-6′ of FIG. 5.

Referring to FIG. 6, a meta-material layer 44 is positioned on a surface of the substrate 42, for example, on an upper surface of the substrate 42, and the first meta-pattern 46 and the second meta-patterns 48 are formed in the meta-material layer 44. It may be seen that the first meta-pattern 46 and the second meta-patterns 48 are through holes that expose the substrate 42. Accordingly, the depth of the through holes is equal to a thickness T1 of the meta-material layer 44. That is, the height of the first meta-pattern 46 and the second meta-patterns 48 is equal to the thickness T1 of the meta-material layer 44. The meta-material layer 44 may have a thickness T1 in a range from about 60 nm to about 100 nm, but the range may be changed according to light used. A protection film 60 is formed on the substrate 42. The thickness and the material of the protection film 60 may be equal to the thickness and material of the protection film 30 of FIG. 3. The protection film 60 is formed along a surface of the meta-material layer 44 and an exposed surface of the substrate 42. Accordingly, the protection film 60 may have the same surface shape or curved shape as the substrate 42 on which the meta-material layer 44 is formed. Accordingly, an entire surface of the protection film may not be flat.

However, the protection film 60 may be formed in a film type that covers the meta-material layer 44, fills the first meta-pattern 46 and the second meta-patterns 48 which are through holes, and has a flat upper surface as an imaginary protection film 62 indicated by a dashed line. At this point, the thickness of the imaginary protection film 62 on an upper surface of the meta-material layer 44 may be equal to the thickness of the protection film 60.

Next, simulations and results of the simulations performed to confirm transmittance and phase retardation of the first QWP 10 and the second QWP 40 according to the example embodiments described above will be described with reference to FIGS. 7 through 22.

The simulations were performed based two cases according to a type of light incident to the first QWP 10 and the second QWP 40. A first case is a case when the light incident to the first QWP 10 and the second QWP 40 is visible light-near infrared ray (vis-NIR). A second case is a case when the light incident to the first QWP 10 and the second QWP 40 is mid-infrared ray (mid-IR).

The simulations in the first case are considered when the first QWP 10 and the second QWP 40 are applied to a detection apparatus based on an ROA method. The simulations in the second case are considered when the first QWP 10 and the second QWP 40 are applied to a detection apparatus based on a VCD method.

The simulations in the first case were performed based on first through eighth simulations.

The first through fourth simulations were performed with respect to the first QWP 10 having the embossed first meta-pattern 14 and the second meta-patterns 16, and the fifth through eighth simulations were performed with respect to the second QWP 40 having the engraved first meta-pattern 46 and the second meta-patterns 48.

In the first through fourth simulations, the first and second simulations were performed under the assumption that the first meta-pattern 14 and the second meta-patterns 16 have a first thickness (60 nm), and the third and fourth simulations were performed under the assumption that the first meta-pattern 14 and the second meta-patterns 16 have a second thickness (100 nm).

Of the first and second simulations, the first simulation was to measure the transmittance of the first QWP 10, and the second simulation was to measure the phase retardation of the first QWP 10.

In the first and second simulations, the dimensions of the unit region 18 and the first meta-pattern 14 and the second meta-patterns 16 of the first QWP 10 were set as Table 1.

TABLE 1

| Thickness | Unit | | First meta- | | Second meta- | | |
|---|---|---|---|---|---|---|---|
| of meta- | region 18 | | pattern 14 | | pattern 16 | | First |
| pattern | L1 | W1 | 14L | 14W | 16L | 16W | distance |
| (nm) | (nm) | (nm) | (nm) | (nm) | (nm) | (nm) | (G1)(nm) |
| 60 | 515 | 425 | 450 | 75 | 220 | 75 | 65 |

Of the third and fourth simulations, the third simulation was to measure transmittance of the first QWP 10, and the fourth simulation was to measure the phase retardation of the first QWP 10.

In the third and fourth simulations, the dimensions of the unit region 18 of the first QWP 10 and the first meta-pattern 14 and the second meta-patterns 16 were set as Table 2.

TABLE 2

| Thickness | Unit | | First meta- | | Second meta- | | |
|---|---|---|---|---|---|---|---|
| of meta- | region 18 | | pattern 14 | | pattern 16 | | First |
| pattern | L1 | W1 | 14L | 14W | 16L | 16W | distance |
| (nm) | (nm) | (nm) | (nm) | (nm) | (nm) | (nm) | (G1)(nm) |
| 100 | 530 | 455 | 450 | 75 | 220 | 75 | 80 |

In the fifth through eighth simulations, the fifth and sixth simulations were performed under the assumption that a depth of the first meta-pattern 46 and the second meta-patterns 48 which are through holes, that is, the thickness of the meta-material layer 44 is equal to the first thickness (60 nm), and the seventh and eighth simulations were performed under the assumption that the thickness of the meta-material layer 44 is equal to the second thickness (100 nm).

Of the fifth and sixth simulations, the fifth simulation was to measure the transmittance of the second QWP 40, and the sixth simulation was to measure the phase retardation of the second QWP 40.

In the fifth and sixth simulations, the dimensions of the unit region 50 and the first meta-pattern 46 and the second meta-patterns 48 of the second QWP 40 were set as Table 3 below.

TABLE 3

| Meta- | Unit | | First meta- | | Second meta- | | |
|---|---|---|---|---|---|---|---|
| material | region 50 | | pattern 46 | | pattern 48 | | Second |
| layer 44 | L2 | W2 | 46L | 46W | 48L | 48W | distance |
| (nm) | (nm) | (nm) | (nm) | (nm) | (nm) | (nm) | (G2)(nm) |
| 60 | 425 | 445 | 395 | 90 | 295 | 100 | 30 |

Of the seventh and eighth simulations, the seventh simulation is about the transmittance of the second QWP 40, and the eighth simulation is about the phase retardation of the second QWP 40.

In the seventh and eighth simulations, the dimensions of the unit region 50 and the first meta-pattern 46 and the second meta-patterns 48 of the second QWP 40 were set as Table 4.

TABLE 4

| Meta- | Unit | | First meta- | | Second meta- | | |
|---|---|---|---|---|---|---|---|
| material | region 50 | | pattern 46 | | pattern 48 | | Second |
| layer 44 | L2 | W2 | 46L | 46W | 48L | 48W | distance |
| (nm) | (nm) | (nm) | (nm) | (nm) | (nm) | (nm) | (G2)(nm) |
| 100 | 435 | 455 | 405 | 90 | 305 | 100 | 30 |

FIGS. 7 through 14 respectively show results of first through eighth simulations.

FIGS. 7 and 9 respectively show the transmittance of the first QWP 10 when the thicknesses of the first meta-pattern 14 and the second meta-patterns 16 of the first QWP 10 are 60 nm and 100 nm. In FIGS. 7 and 9, the horizontal axis represents a wavelength of light (visible light˜near infrared ray (NIR)), and the vertical axis represents transmittance. In FIGS. 7 and 9, first graphs G71 and G91 and second graphs G72 and G92 show transmittance with respect to linearly polarized lights that are perpendicular to each other. The first graphs G71 and G91 respectively show transmittance with respect to linearly polarized light in the y-axis direction, and the second graphs G72 and G92 respectively show transmittance with respect to linearly polarized light in the x-axis direction.

In FIGS. 7 and 9, referring to the first graphs G71 and G91 and the second graphs G72 and G92, when the thicknesses of the first meta-pattern 14 and the second meta-patterns 16 are 60 nm and 100 nm, both cases show that the transmittance of the linearly polarized light in the y-axis direction is increased as the increase in the wavelength and the transmittance of the linearly polarized light in the x-axis direction is gradually reduced as the increase in the wavelength.

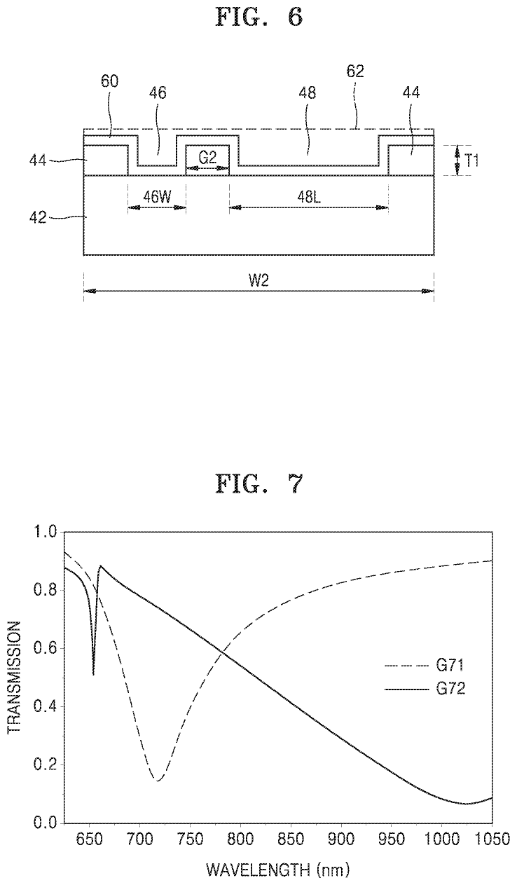

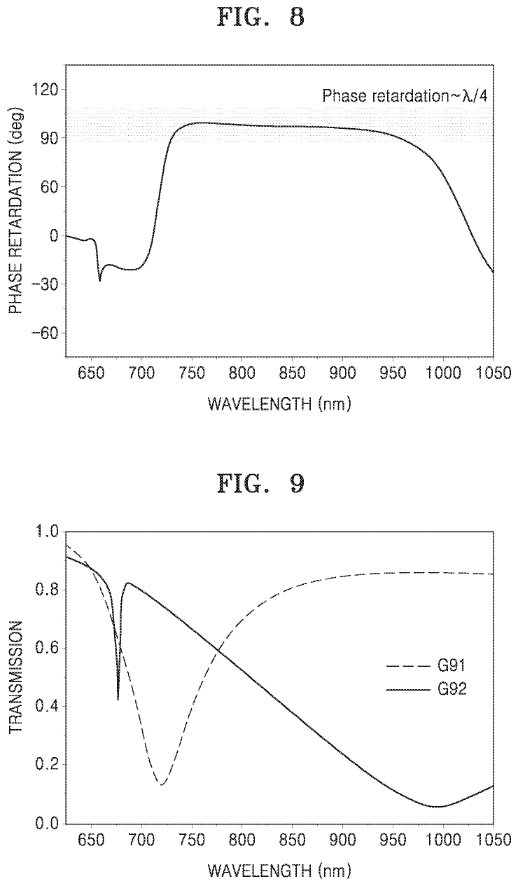

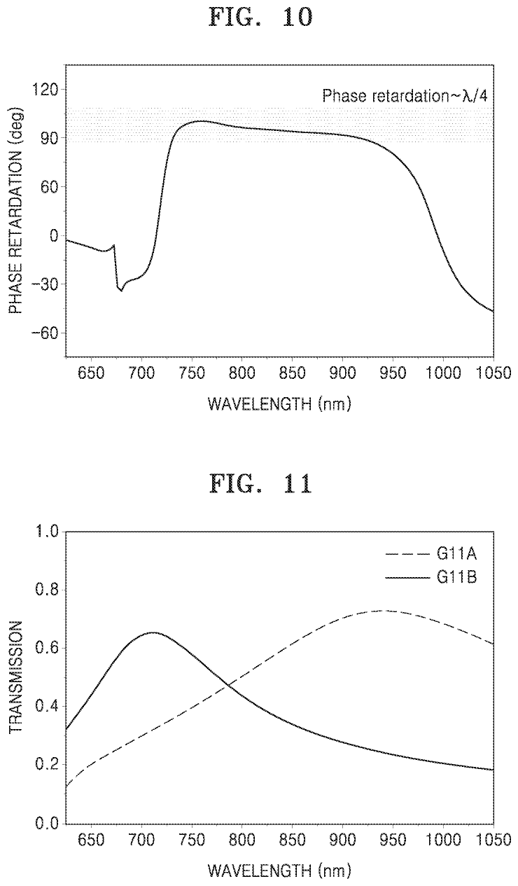

FIGS. 8 and 10 show results of the second and fourth simulations, and respectively show the phase retardations of the first QWP 10 when the thicknesses of the first meta-pattern 14 and the second meta-patterns 16 of the first QWP 10 are 60 nm and 100 nm. In FIGS. 8 and 10, the horizontal axis represents wavelength of light (visible light˜NIR), and the vertical axis represents the phase retardation.

Referring to FIGS. 8 and 10, in an interval between a long wavelength range of visible light (700 nm<) and a near infrared range (<1000 nm), the phase retardation of a wavelength (λ/4) appears between the linearly polarized light in the x-axis direction and the linearly polarized light in the y-axis direction. The result indicates that when light (linearly polarized light in the x-axis direction and linearly polarized light in the y-axis direction) of the long wavelength range of visible light and the near infrared range passes the first QWP 10, the light becomes circularly polarized light. In other words, FIGS. 8 and 10 indicate that the first QWP 10 is a QWP that changes linearly polarized light of the long wavelength range of visible light and the near infrared range to circularly polarized light.

Accordingly, the first QWP 10 may be used as a QWP of a detection apparatus that detects a biomaterial having chirality by measuring Raman intensity. That is, the first QWP 10 may be used as a QWP of a biomaterial detection apparatus based on a ROA method.

FIGS. 11 and 13 respectively show transmittance of the second QWP 40 including an engraved meta-pattern when the thicknesses of the meta-material layer 44 of the second QWP 40 are 60 nm and 100 nm. In FIGS. 11 and 13, the horizontal axis represents wavelength of light (visible light˜NIL), and the vertical axis represents transmittance. First and second graphs G11A and G11B of FIG. 11 and first and second graphs G13A and G13B of FIG. 13 show transmittance with respect to linearly polarized lights that are perpendicular to each other. In FIGS. 11 and 13, the first graphs G11A and G13A show transmittance with respect to linearly polarized light in the y-axis direction and the second graphs G11B and G13B show transmittance with respect to linearly polarized light in the x-axis direction.

In FIGS. 11 and 13, referring to the first graphs G11A and G13A and the second graphs G11B and G13B, when a depth of the first meta-pattern 46 and the second meta-patterns 48, that is, the thicknesses of the meta-material layer 44 are 60 nm and 100 nm, both cases show that the transmittance of the linearly polarized light in the y-axis direction increases as the increase in the wavelength until the wavelength increases to 950 nm, but is reduced afterwards. The transmittance of the linearly polarized light in the x-axis direction is the maximum near at the wavelength of 700 nm, and afterwards, gradually decreases as the wavelength increases.

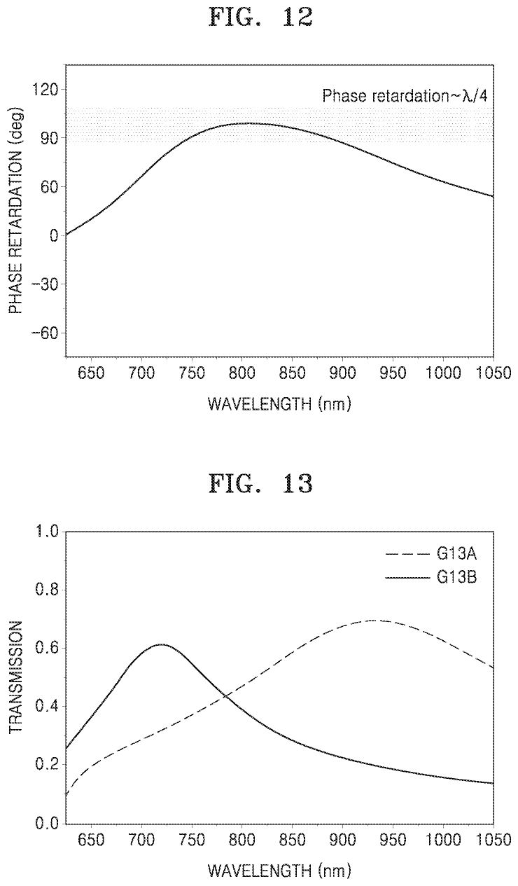

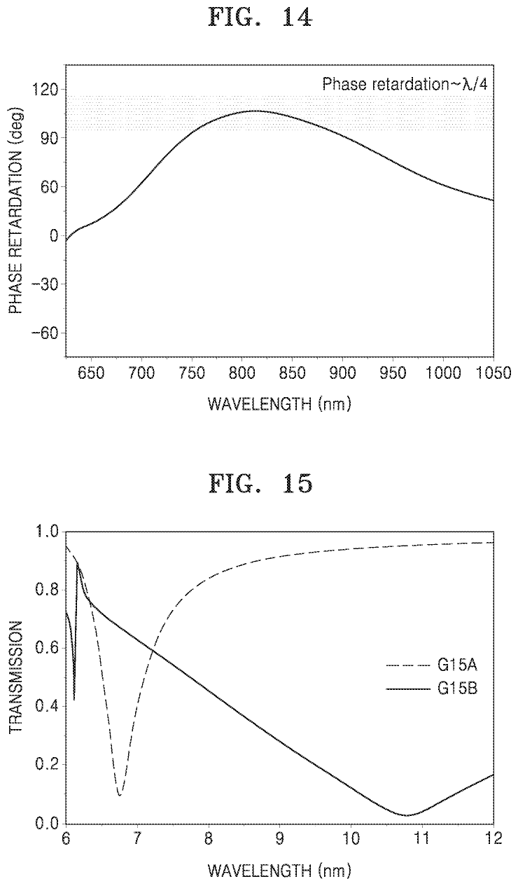

FIGS. 12 and 14 show the results of sixth and eighth simulations, and respectively show the phase retardations of the second QWP 40 when the thicknesses of the meta-material layer 44 of the second QWP 40 are 60 nm and 100 nm. In FIGS. 12 and 14, the horizontal axis represents wavelength of light (visible light˜NIR), and the vertical axis represents the phase retardation.

Referring to FIGS. 12 and 14, in an interval between a long wavelength range of visible light (700 nm<) and a near infrared range (<950 nm), the phase retardation of a wavelength (λ/4) appears between the linearly polarized light in the x-axis direction and the linearly polarized light in the y-axis direction. The result indicates that when light (linearly polarized light in the x-axis direction and linearly polarized light in the y-axis direction) of a long wavelength range of visible light and a near infrared range passes through the second QWP 40, the light becomes circularly polarized light. In other words, FIGS. 12 and 14 indicate that the second QWP 40 may be a QWP that changes linearly polarized light of the long wavelength range of visible light and the near infrared range to circularly polarized light like the first QWP 10.

Accordingly, like the first QWP 10, the second QWP 40 may be used as a QWP of a detection apparatus that detects a biomaterial having chirality by measuring Raman intensity. That is, the second QWP 40 may be used as a QWP of a biomaterial detection apparatus based on a ROA method.

The simulations in the second case were performed by dividing into ninth to sixteenth simulations.

The ninth through twelfth simulations were performed with respect to the first QWP 10 having the embossed first meta-pattern 14 and the second meta-patterns 16, and the thirteenth through sixteenth simulations were performed with respect to the second QWP 40 having the engraved first meta-pattern 46 and the second meta-patterns 48.

In the ninth through twelfth simulations, the ninth and tenth simulations were performed under the assumption that the thickness of the first meta-pattern 14 and the second meta-patterns 16 is equal to the first thickness (60 nm), and the eleventh and twelfth simulations were performed under the assumption that the thickness of the first meta-pattern 14 and the second meta-patterns 16 is equal to the second thickness (100 nm).

Of the ninth and tenth simulations, the ninth simulation was to measure the transmittance of the first QWP 10, and the tenth simulation was to measure the phase retardation of the first QWP 10.

In the ninth and tenth simulations, the dimensions of the unit region 18 and the first meta-pattern 14 and the second meta-patterns 16 of the first QWP 10 are set as Table 5 below.

TABLE 5

| Thickness | Unit | | First meta- | | Second meta- | | |
|---|---|---|---|---|---|---|---|
| of meta- | region 18 | | pattern 14 | | pattern 16 | | First |
| pattern | L1 | W1 | 14L | 14W | 16L | 16W | distance |
| (nm) | (μm) | (μm) | (μm) | (μm) | (μm) | (μm) | (G1)(μm) |
| 60 | 4.75 | 3.15 | 4.6 | 0.7 | 2 | 0.6 | 0.2 |

Of the eleventh and twelfth simulations, the eleventh simulation was to measure the transmittance of the first QWP 10, and the twelfth simulation was to measure the phase retardation of the first QWP 10.

In the eleventh and twelfth simulations, the dimensions of the unit region 18 and the first meta-pattern 14 and the second meta-patterns 16 of the first QWP 10 are set as Table 6 below.

TABLE 6

| Thickness | Unit | | First meta- | | Second meta- | | |
|---|---|---|---|---|---|---|---|
| of meta- | region 18 | | pattern 14 | | pattern 16 | | First |
| pattern | L1 | W1 | 14L | 14W | 16L | 16W | distance |
| (nm) | (μm) | (μm) | (μm) | (μm) | (μm) | (μm) | (G1)(μm) |
| 100 | 5.20 | 3.10 | 5.0 | 0.7 | 1.8 | 0.7 | 0.2 |

In the thirteenth through sixteenth simulations, the thirteenth and fourteenth simulations were performed under the assumption that a depth of the first meta-pattern 46 and the second meta-patterns 48, which are through holes, that is, the thickness of the meta-material layer 44, is equal to the first thickness (60 nm), and the fifteenth and sixteenth simulations were performed under the assumption that the thickness of the meta-material layer 44 is equal to the second thickness (100 nm).

Of the thirteenth and fourteenth simulations, the thirteenth simulation was to measure the transmittance of the second QWP 40, and the fourteenth simulation was to measure the phase retardation of the second QWP 40.

In the thirteenth and fourteenth simulations, the dimensions of the unit region 50 and the first meta-pattern 46 and the second meta-patterns 48 of the second QWP 40 are set as Table 7 below.

TABLE 7

| Thickness | | | | | | | |
|---|---|---|---|---|---|---|---|
| of meta- | Unit | | First meta- | | Second meta- | | |
| material | region 50 | | pattern 46 | | pattern 48 | | Second |
| layer 44 | L2 | W2 | 46L | 46W | 48L | 48W | distance |
| (nm) | (μm) | (μm) | (μm) | (μm) | (μm) | (μm) | (G2)(μm) |
| 60 | 4.9 | 3.8 | 4.7 | 1.0 | 2.1 | 0.8 | 0.2 |

Of the fifteenth and sixteenth simulations, the fifteenth simulation was to measure the transmittance of the second QWP 40, and the sixteenth simulation was to measure the phase retardation of the second QWP 40.

In the fifteenth and sixteenth simulations, the dimensions of the unit region 50 and the first meta-pattern 46 and the second meta-patterns 48 of the second QWP 40 are set as Table 7 below.

TABLE 8

| Thickness | | | | | | | |
|---|---|---|---|---|---|---|---|
| of meta- | | | First meta- | | Second meta- | | |
| material | Unit region 50 | | pattern 46 | | pattern 48 | | Second |
| layer 44 | L2 | W2 | 46L | 46W | 48L | 48W | distance |
| (nm) | (μm) | (μm) | (μm) | (μm) | (μm) | (μm) | (G2)(μm) |
| 100 | 5.0 | 3.8 | 4.7 | 1.1 | 2.1 | 0.9 | 0.2 |

FIGS. 15 through 22 respectively show results of the ninth through sixteenth simulations.

FIGS. 15 and 17 respectively show the transmittance of the first QWP 10 when the thicknesses of the first meta-pattern 14 and the second meta-patterns 16 of the first QWP 10 are 60 nm and 100 nm. In FIGS. 15 and 17, the horizontal axis represents wavelength of light, that is, wavelength of mid-IR of an infrared band, and the vertical axis represents transmittance of the mid-IR of the infrared band. In FIGS. 15 and 17, first graphs G15A and G17A and second graphs G15B and G17B show transmittance with respect to linearly polarized lights that are perpendicular to each other. The first graphs G15A and G17A show transmittance with respect to linearly polarized light in the y-axis direction and the second graphs G15B and G17B show transmittance with respect to linearly polarized light in the x-axis direction, respectively.

In FIGS. 15 and 17, referring to the first graphs G15A and G17A and second graphs G15B and G17B, when the thicknesses of the first meta-pattern 14 and the second meta-patterns 16 are 60 nm and 100 nm, both cases show that the transmittance of the linearly polarized light in the y-axis direction increases as the increase in the wavelength and the transmittance of the linearly polarized light in the x-axis direction gradually decreases as the increase in the wavelength.

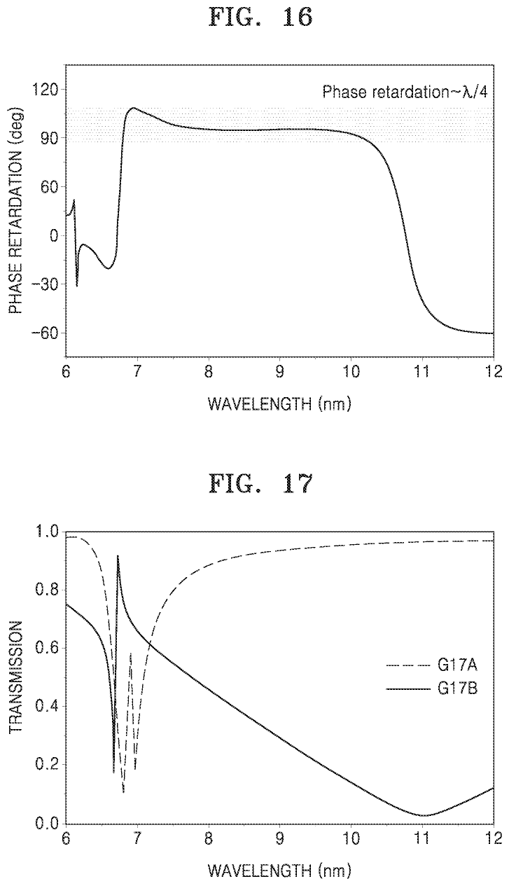

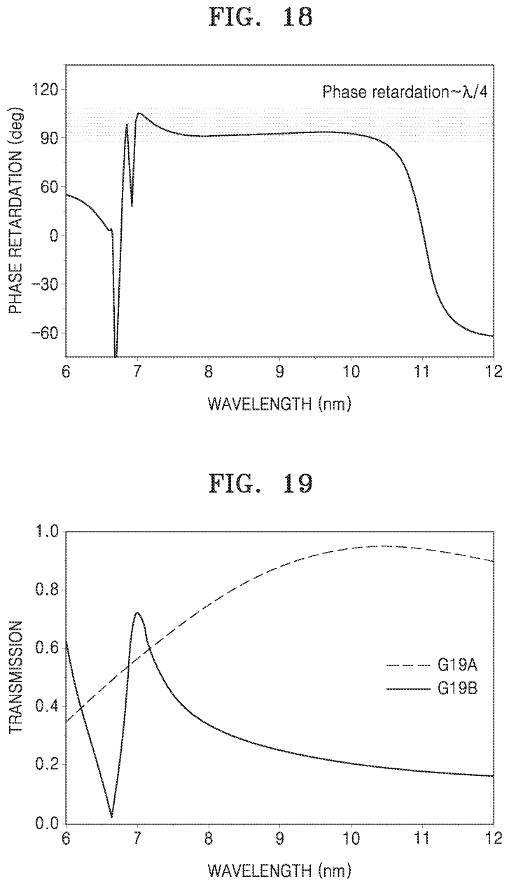

FIGS. 16 and 18 show the results of tenth and twelfth simulations, and respectively show the phase retardation of the first QWP 10 when the thicknesses of the first meta-pattern 14 and the second meta-patterns 16 of the first QWP 10 are 60 nm and 100 nm. In FIGS. 16 and 18, the horizontal axis represents the wavelength of mid-IR, and the vertical axis represents the phase retardation of light.

Referring to FIGS. 16 and 18, a phase retardation of a wavelength (λ)/4 appears between the linearly polarized light in the x-axis direction and the linearly polarized light in the y-axis direction of light that belongs to mid-IR. This result indicates that, when light (linearly polarized light in the x-axis direction and linearly polarized light in the y-axis direction) that belongs to mid-IR passes through the first QWP 10, the light becomes circularly polarized light. In other words, FIGS. 16 and 18 indicate that the first QWP 10 is a QWP that converts linearly polarized light that belongs to the intermediate wavelength range of the IR band to circularly polarized light.

Accordingly, the first QWP 10 may be used as a QWP of a detection apparatus that detects a biomaterial having chirality by measuring an absorbance difference of light that belongs to an intermediate wavelength range of the IR band. That is, the first QWP 10 may be used as a QWP of a biomaterial detection apparatus based on a VCD method.

FIGS. 19 and 21 show results of thirteenth and fifteenth simulations, and show the transmittance of the second QWP 40 including an engraved meta-pattern when the thicknesses of the meta-material layer 44 of the second QWP 40 are 60 nm and 100 nm. In FIGS. 19 and 21, the horizontal axis represents the wavelength of light that belongs to an intermediate wavelength range of an IR band, and the vertical axis represents the transmittance. First and second graphs G19A and G19B of FIG. 19 and first and second graphs G21A and G21B of FIG. 21 show transmittance with respect to linearly polarized lights that are perpendicular to each other. In FIGS. 19 and 21, the first graphs G19A and G21A show transmittance with respect to linearly polarized light in the y-axis direction, and the second graphs G19B and G21B show the transmittance with respect to linearly polarized light in the x-axis direction, respectively.

In FIGS. 19 and 21, referring to the first graphs G19A and G21A and the second graphs G19B and G21B, when a depth of the first meta-pattern 46 and the second meta-patterns 48, that is, the thicknesses of the meta-material layer 44 are 60 nm and 100 nm, both cases show a tendency that the transmittance of linearly polarized light in the y-axis direction increases as the increase in the wavelength. However, the transmittance increases until the wavelength is 10 μm, and afterwards, it decreases. The transmittance of linearly polarized light in the x-axis direction is maximum near at the wavelength of 7 μm, and afterwards, it decreases as the increase in the wavelength.

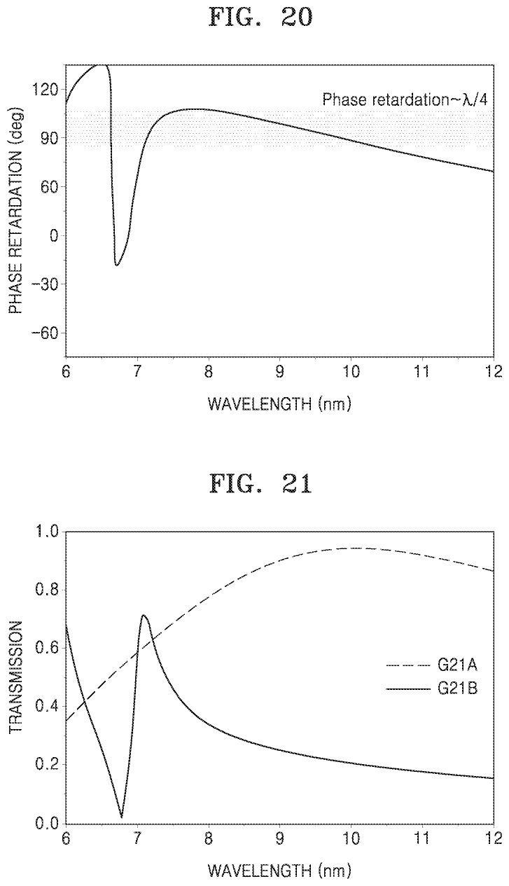

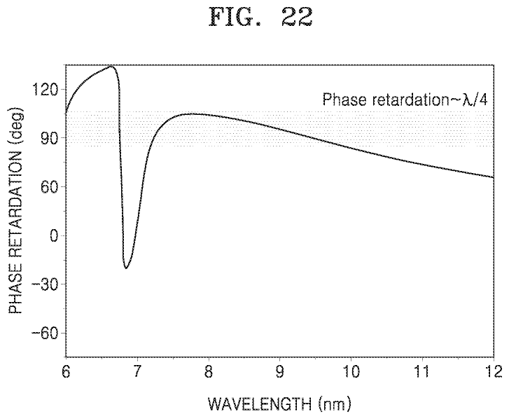

FIGS. 20 and 22 show results of fourteenth and sixteenth simulations, and respectively show the phase retardation of the second QWP 40 when the thicknesses of the meta-material layer 44 are 60 nm and 100 nm. In FIGS. 20 and 22, the horizontal axis represents wavelength of mid-IR, and the vertical axis represents phase retardation.

Referring to FIGS. 20 and 22, the phase retardation of a wavelength λ/4 appears between linearly polarized light in the x-axis direction and linearly polarized light in the y-axis direction at a wavelength in a range from about 7 μm to about 10 μm that belongs to mid-IR. The result indicates that, when light (linearly polarized light in the x-axis direction and linearly polarized light in the y-axis direction) that belongs to the mid-IR passes through the second QWP 40, the light may become circularly polarized light. In other words, FIGS. 20 and 22 indicate that, like the first QWP 10, the second QWP 40 may also be a QWP that converts linearly polarized light that belongs to an intermediate wavelength range of infrared ray into circularly polarized light.

Accordingly, like the first QWP 10, the second QWP 40 may also be used as a QWP of a biomaterial detection apparatus having chirality by measuring light absorbance difference with respect to an intermediate wavelength range of infrared ray. That is, like the first QWP 10, the second QWP 40 may be used as a QWP of a biomaterial detection apparatus based on a VCD method.

Next, a method of manufacturing a QWP according to the example embodiments will be described with reference to FIGS. 23 through 30. In the drawings, reference numerals identical to the reference numerals described above may indicate identical elements, and the descriptions thereof will not be repeated.

FIGS. 23 through 26 are cross-sectional views or plan views showing the operations of a method of manufacturing the QWP 10 described above.

Referring to FIG. 23, a first meta-material layer 230 is formed on the substrate 12. The first meta-material layer 230 may be formed by, for example, a method of depositing a material film. The first meta-material layer 230 may include the same material as the material used to form the first meta-pattern 14 and the second meta-patterns 16 of the first QWP 10. The first meta-material layer 230 may be formed to a given thickness, for example, may be formed to a thickness value less than a wavelength of incident light. As an example, the first meta-material layer 230 may be formed to a thickness value corresponding to a half of or less than the wavelength of incident light. The first meta-material layer 230 may be formed to correspond to a thickness of the first meta-pattern 14 and the second meta-patterns 16 of the first QWP 10. After the first meta-material layer 230 is formed, a mask layer M1+M2 for partly etching the first meta-material layer 230 is formed on the first meta-material layer 230. The mask layer M1+M2 includes the first mask pattern M1 and the second mask pattern M2 that define or cover regions different from each other of the first meta-material layer 230. The first mask pattern M1 and the second mask pattern M2 are spaced apart from each other, and thus, do not contact each other. Accordingly, the first meta-material layer 230 around the first mask pattern M1 and the second mask pattern M2 is exposed.

A region defined by one of the first mask pattern M1 and the second mask pattern M2 may correspond to one of the first meta-pattern 14 and the second meta-patterns 16 of the first QWP 10, and a region defined by the remaining one of the first mask pattern M1 and the second mask pattern M2 may correspond to the remaining one of the first meta-pattern 14 and the second meta-patterns 16. The first mask pattern M1 and the second mask pattern M2 may be mask patterns separated from a single mono-layer mask. Accordingly, a material of the first mask pattern M1 may be the same as that of the second mask pattern M2.

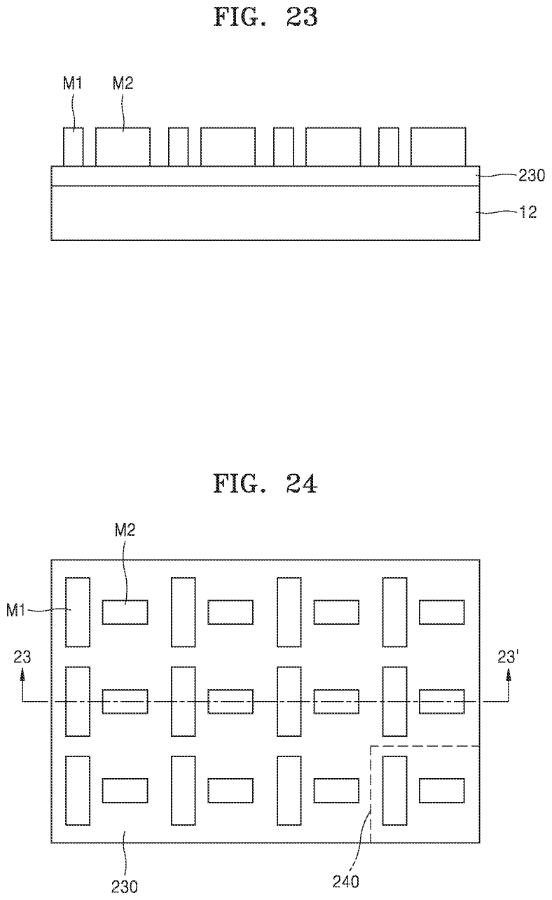

FIG. 24 is a plan view of the first QWP 10 of FIG. 23. FIG. 23 is a cross-sectional view taken along line 23-23′ of FIG. 24.

When the first mask pattern M1 and the second mask pattern M2 of FIG. 24 are compared to the first meta-pattern 14 and the second meta-patterns 16 of the first QWP 10, the shape and the mutual arrangement type of each of the first mask pattern M1 and the second mask pattern M2 may be similar to that of the first meta-pattern 14 and the second meta-patterns 16 of the first QWP 10. As an example, the shape and the mutual arrangement type of each of the first mask pattern M1 and the second mask pattern M2 may be equal to the first meta-pattern 14 and the second meta-patterns 16 of the first QWP 10. Accordingly, when the first mask pattern M1 and the second mask pattern M2 are formed, the dimensions in horizontal and vertical directions and the dimension of a mutual separation-distance of each of the first mask pattern M1 and the second mask pattern M2 may be set to correspond to the first meta-pattern 14 and the second meta-patterns 16 of the first QWP 10. Accordingly, the first mask pattern M1 and the second mask pattern M2 may have nanometer dimensions or micrometer dimensions according to a detection apparatus to which the first QWP 10 is applied.

A unit region 240 including the first mask pattern M1 and the second mask pattern M2 may be set on a surface of the first meta-material layer 230 on which the mask layer M1+M2 is formed. The unit region 240 may be set to correspond to the unit region 18 of FIG. 1.

After the first mask pattern M1 and the second mask pattern M2 are formed, the first meta-material layer 230 around the first mask pattern M1 and the second mask pattern M2 is removed. At this point, the first meta-material layer 230 may be removed by using an etching process. The etching process may be a generally well known etching process. The etching process may be performed until the substrate 12 is exposed. Afterwards, the first mask pattern M1 and the second mask pattern M2 are removed.

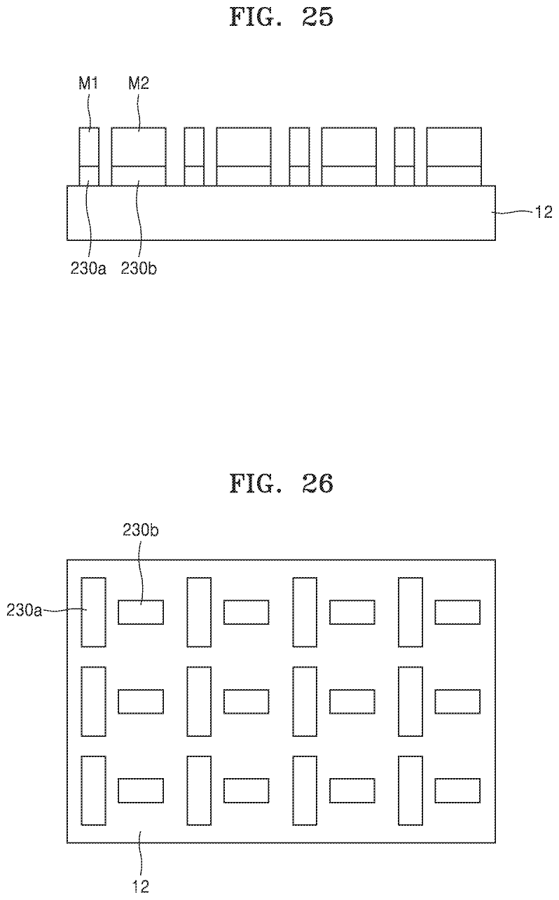

FIG. 25 is a cross-sectional view showing a shape before removing the first mask pattern M1 and the second mask pattern M2 after the etching process is performed.

FIG. 26 is a plan view showing a shape after removing the first mask pattern M1 and the second mask pattern M2 after the etching process is performed.

As a result of the etching process, the first meta-material layer 230 around the first mask pattern M1 and the second mask pattern M2 are completely removed, and thus, as depicted in FIGS. 25 and 26, a first meta-material layer pattern 230a and 230b having the same shapes as the first mask pattern M1 and the second mask pattern M2 remain on the substrate 12. As a result, the first mask pattern M1 and the second mask pattern M2 are correctly transferred to the first meta-material layer 230. After the first mask pattern M1 and the second mask pattern M2 are removed, a first pattern 230a and a second pattern 230b of the first meta-material layer 230 remaining on the substrate 12 may respectively correspond to the first meta-pattern 14 and the second meta-patterns 16 of the first QWP 10.

In this way, the first QWP 10 having the embossed first meta-pattern 14 and the second meta-patterns 16 that protrude on the substrate 12 may be formed.

After the first mask pattern M1 and the second mask pattern M2 are removed, a protection film covering the first meta-material layer pattern 230a and 230b of the first meta-material layer 230 may be formed on the substrate 12. The protection film may be the protection film 30 described with reference to FIG. 3. Considering that each of the first meta-material layer pattern 230a and 230b may have a nanometer dimension, the protection film may be formed by using a chemical vapor deposition (CVD) method or an atomic layer deposition (ALD) method, but example embodiments are not limited thereto.

Next, a method of manufacturing the second QWP 40 including the engraved first meta-pattern 46 and the second meta-patterns 48 will be described.

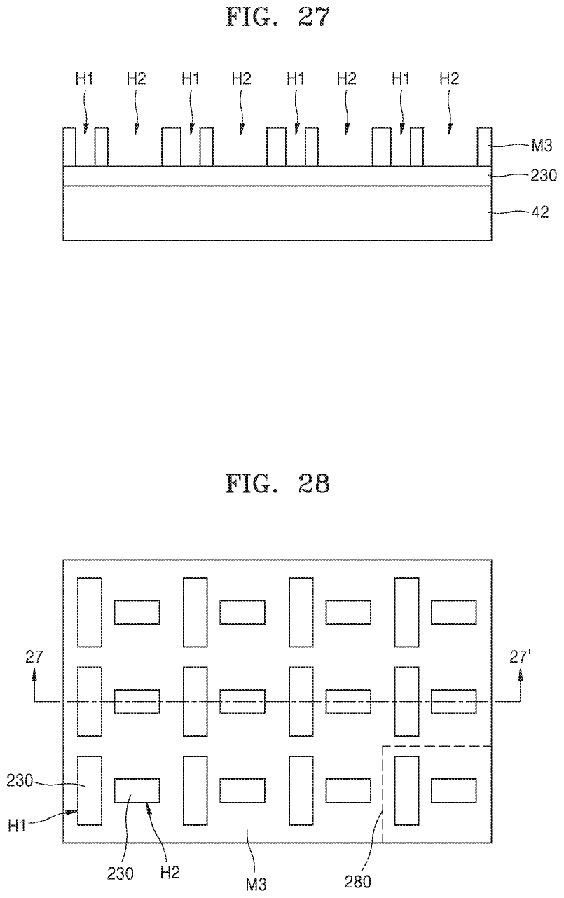

Referring to FIG. 27, a first meta-material layer 230 is formed on a substrate 42. The substrate 42 may be a flexible substrate or an inflexible substrate. As an example, the substrate 42 may be the substrate 12 described in the method of manufacturing the first QWP 10. A mask layer M3 is formed on the first meta-material layer 230. The mask layer M3 may be a photosensitive film. As depicted in FIG. 28, the mask layer M3 may be formed as a shape defining the first meta-pattern 46 and the second meta-patterns 48 of the second QWP 40. The mask layer M3 may include a first hole H1 and a second hole H2. The first meta-material layer 230 may be exposed through the first hole H1 and the second hole H2.

FIG. 28 is a plan view of FIG. 27. FIG. 27 is a cross-sectional view taken along line 27-27′ of FIG. 28.

Referring to FIG. 28, the mask layer M3 is a single mono-layer. The first hole H1 and the second hole H2 are separated from each other. The dimension and the mutual arrangement type of each of the first hole H1 and the second hole H2 may be formed to correspond to the dimension and the mutual arrangement type of each of the first meta-pattern 46 and the second meta-patterns 48 formed in the second QWP 40. Accordingly the first hole H1 and the second hole H2 of the mask layer M3 may have nanometer dimensions or micrometer dimensions according to a detection apparatus to which the second QWP 40 is applied. The first hole H1 and the second hole H2 of the mask layer M3 may be formed by using, for example, an electron beam or an extreme ultraviolet exposure apparatus. A unit region 280 including the first hole H1 and the second hole H2 may be set in the mask layer M3. The unit region 280 may be set to correspond to the unit region 50 (refer to FIG. 4) of the second QWP 40.

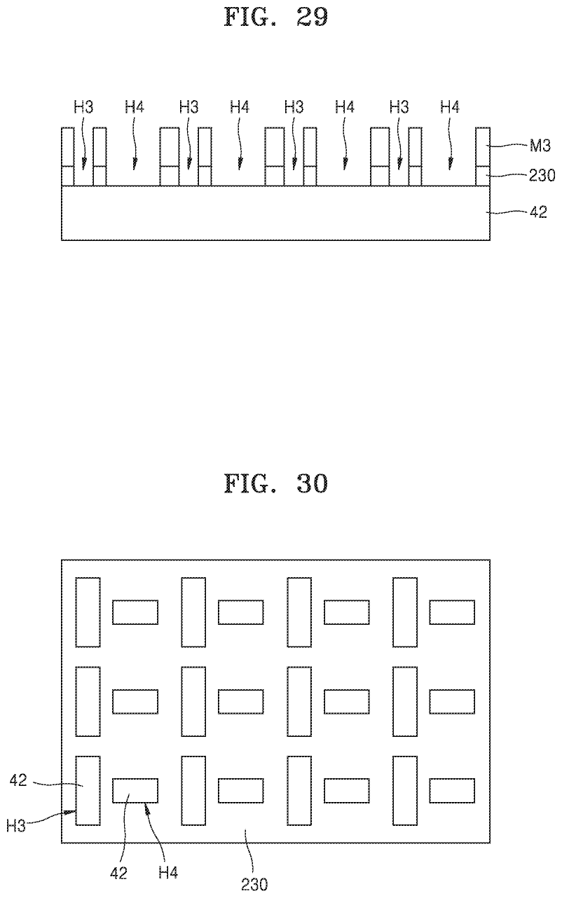

After the mask layer M3 having the first hole H1 and the second hole H2 is formed, portions of the first meta-material layer 230 exposed through the first hole H1 and the second hole H2 are etched. At this point, the etching is performed until the substrate 42 is exposed. As a result of the etching, as depicted in FIG. 29, a plurality of a third hole H3 and a fourth hole H4 are formed in the first meta-material layer 230. The third hole H3 and the fourth hole H4 may be regarded as the extension of the first hole H1 and the second hole H2 formed in the mask layer M3 into the first meta-material layer 230. Portions of the substrate 42 are exposed through the third hole H3 and the fourth hole H4. After the third hole H3 and the fourth hole H4 are formed in the first meta-material layer 230, the mask layer M3 is removed.

FIG. 30 shows a plane of the first meta-material layer 230 remaining on the substrate 42 after the mask layer M3 is removed. The shape and the mutual arrangement type of each of the third hole H3 and the fourth hole H4 may be equal to the shape and the mutual arrangement type of each of the first hole H1 and the second hole H2 formed in the mask layer M3. The third hole H3 and the fourth hole H4 formed in the first meta-material layer 230 may be considered as that the first hole H1 and the second hole H2 formed in the mask layer M3 are transferred to the first meta-material layer 230. The third hole H3 and the fourth hole H4 of the first meta-material layer 230 may correspond to the first meta-pattern 46 and the second meta-patterns 48 of the second QWP 40.

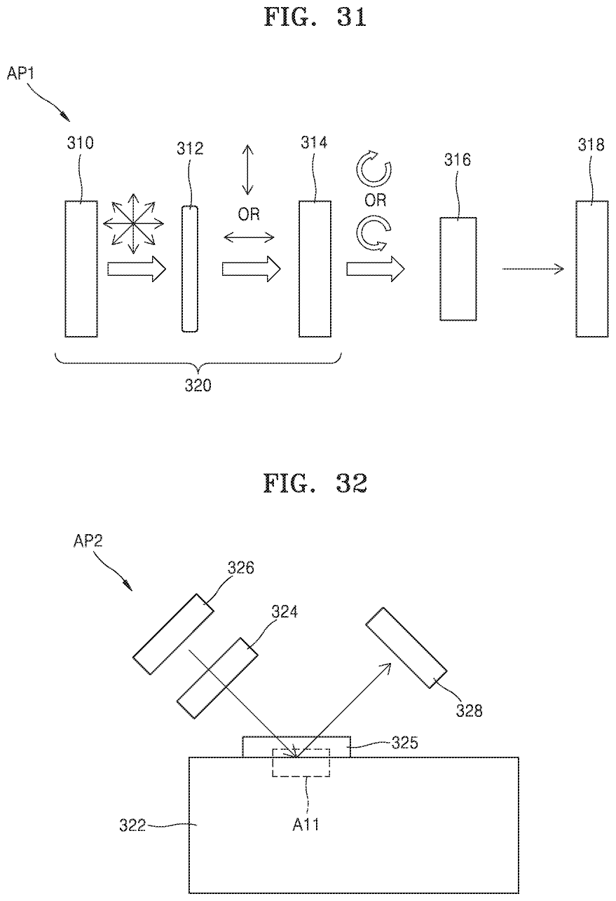

Next, detection apparatuses according to example embodiments will be described with reference to FIGS. 31 through 36.

The detection apparatuses described below may be apparatuses for detecting a given material, for example, a biomaterial. The biomaterial may have a given optical characteristic for identification, for example, a biomaterial having chirality. The biomaterial having chirality may be Saccharide, DNA, poly peptide, Mirtazapine (medicine for depression), protein, etc., but is not limited thereto.

The detection apparatuses described below may be detection apparatuses based on a ROA method or a VCD method, and may include the first QWP 10 or the second QWP 40 described above.

FIG. 31 shows a first detection apparatus AP1 according to an example embodiment.

Referring to FIG. 31, the first detection apparatus AP1 includes a light source 310, a polarizer 312, a QWP 314, and a detector 318. An object 316 is positioned between the QWP 314 and the detector 318. The light source 310 may be a light source configured to emit unpolarized light. The light source 310 may be a light source that emits parallel light and may emit coherent light or incoherent light. The light source 310 may include a light source that emits visible light and/or infrared ray. The infrared ray may include at least near infrared ray and mid-infrared ray. The mid-infrared ray may denote infrared ray corresponding to a medium range in the entire infrared range. The polarizer 312 may be a linear polarizer that converts light emitted from the light source 310 into a linearly polarized light. The QWP 314 may be a polarizer that converts linearly polarized light incident from the polarizer 312 into right or left circularly polarized light through phase retardation. The QWP 314 may include, for example, the first QWP 10 or the second QWP 40. Circularly polarized light is generated by combining the polarizer 312 and the QWP 314, and thus, the combination of the polarizer 312 and the QWP 314 may be referred to as a circular polarizer or a circular polarizing plate. The light source 310, the polarizer 312, and the QWP 314 altogether may be referred to as a circularly polarized light emitting unit 320. The detector 318 receives an optical signal generated from the object, and may be, for example, a photodiode. The optical signal may include an optical signal appearing from a chirality characteristic of a biomaterial included in the object 316. The object 316 may be a biomaterial itself to be detected or a biomaterial included on a surface or inside of the object 316.

FIG. 32 shows a second detection apparatus AP2 according to another example embodiment.

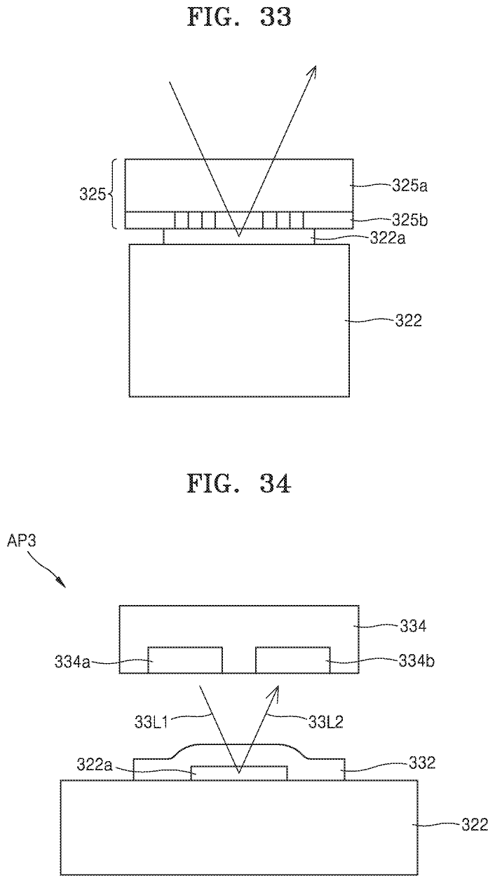

Referring to FIG. 32, the second detection apparatus AP2 includes a light source 326, a polarizer 324, a QWP 325, and a detector 328. The light source 326 may be the light source 310 of FIG. 31. When the light source 326 includes a linear polarizer, the polarizer 324 may be omitted. In another example embodiment, when the light source 326 is the circularly polarized light emitting unit 320 of FIG. 31, the polarizer 324 and the QWP 325 may be omitted. The polarizer 324 may include a linear polarizer. The QWP 325 may be attached to a surface of a subject 322. The object 322a (refer to FIG. 33) may be positioned between the QWP 325 and the subject 322. The subject 322 may be all objects, for example, all solid bodies having a flat or curved surface that may be stained with a biomaterial or another contaminant. As an example, the subject 322 may be all solid bodies having a surface, such as various household items or tools, electronic products, transportation means and so on. The QWP 325 converts linearly polarized light incident from the polarizer 324 into circularly polarized light. The QWP 325 may be the first QWP 10 or the second QWP 40. The QWP 325 may have flexibility, and thus, may bend. Light emitted from the light source 326 enters an object through the polarizer 324 and the QWP 325, and light incident to the object is emitted by including an optical signal that includes an optical absorption characteristic or an optical scattering characteristic of the object with respect to a circular polarization state of the incident light. Light emitted from the object passes through the QWP 325. The detector 328 may be arranged so that the detector 328 detects the optical signal emitted from the object through the QWP 325. The detector 328 may be the detector 318 of FIG. 31.

FIG. 33 is a magnified cross-sectional view of a first region A11 of FIG. 32.

Referring to FIG. 33, an object 322a is positioned between the subject 322 and the QWP 325. The object 322a is completely covered by the QWP 325. The QWP 325 directly contacts the object 322a. The QWP 325 includes a substrate 325a and a meta-pattern layer 325b formed on a surface of the substrate 325a. The meta-pattern layer 325b directly contacts the object 322a. However, in another example embodiment, another surface of the substrate 325a, that is, a surface on which the meta-pattern layer 325b is not formed may directly contact the object 322a. The meta-pattern layer 325b may be a layer including the first meta-pattern 14 and the second meta-patterns 16 of the first QWP 10 or may be the meta-material layer 44 including the engraved first meta-pattern 46 and the second meta-patterns 48 of the second QWP 40. Since the meta-pattern layer 325b contacts the object 322a, light emitted from the object 322a may obtain an effect by an SERS technique. That is, a field of light emitted from the object 322a may be reinforced while passing through the meta-pattern layer 325b. This indicates that an optical signal emitted from the object 322a is amplified, and thus, even though the optical signal emitted from the object 322a is weak, the optical signal may be sufficiently detected. The weakness of the optical signal may occur when the object 322a is very small amount, but the very small amount of the object 322a may be detected by using the QWP 325. This result may be obtained in all detection apparatuses in which a meta-pattern directly contacts an object.

FIG. 34 shows a third detection apparatus AP3 according to another example embodiment.

Referring to FIG. 34, the third detection apparatus AP3 may include a main body 334 and a QWP 332. The QWP 332 may be attached to a surface of the subject 322. The object 322a to be detected is positioned on a surface of the subject 322, and the QWP 332 may be attached to the surface of the subject 322 in a form of covering the entire or a portion of the object 322a. The main body 334 may include a light source 334a and a detector 334b. In an example embodiment, the light source 334a may include a light emitter and a linear polarizer. Here, the light source may include the light source 310 of FIG. 31 or a light source that emits light equivalent to that of the light source 310. The linear polarizer may include the polarizer 312 of FIG. 31 or a polarization means that shows a polarization characteristic equivalent to that of the polarizer 312. In another example embodiment, the light source 334a may include a light emitter that emits linearly polarized light. The QWP 332 may be the first QWP 10 or the second QWP 40. The detector 334b detects an optical signal emitted from the object 322a. The detector 334b may include a photodiode, and may include a device for processing the optical signal.

Linearly polarized light 33L1 is emitted from the light source 334a, and the emitted linearly polarized light enters the object 322a through the QWP 332. An optical characteristic difference, for example, a light absorbance difference or a Raman signal difference with respect to right-circular polarized light and left-circular polarized light may differently appear according to the type of the object 322a, and thus, the type of the object 322a may be known by measuring the optical characteristic difference. The type of the object 322a may be detected through a comparison of measured data for the object 322a and pre-acquired reference data. Circularly polarized light incident to the object 322a is emitted with an optical signal including the optical characteristic difference of the object 322a. Light 33L2 emitted from the object 322a enters the detector 334b of the main body 334 through the QWP 332. The detector 334b may find the type of the object 322a by measuring the incident optical signal, and may also quantify a specific biomaterial included in the object 322a through a given signal handling process.

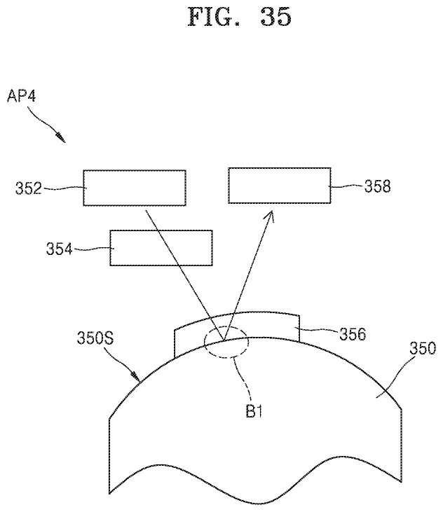

FIG. 35 shows a fourth detection apparatus AP4 according to another example embodiment.

Referring to FIG. 35, the fourth detection apparatus AP4 may include a light source 352, a polarizer 354, a QWP 356 having flexibility, and a detector 358. The light source 352 may be the light source 326 of FIG. 32. The polarizer 354 may include a linear polarizer or a linear polarization plate that converts unpolarized light entering from the light source 352 to linearly polarized light. The polarizer 354 may be the polarizer 324 of FIG. 32. The QWP 356 is attached onto a curved surface 350S of a subject 350. The QWP 356 may cover a portion of a surface of the subject 350 along the curved surface 350S. After a detection process of an object is finished, the QWP 356 may be separated from the subject 350. The QWP 356 is a wavelength plate that converts linearly polarized light entering from the polarizer 354 into circularly polarized light by retarding a phase of the linearly polarized light entering from the polarizer 354. The object is positioned between the QWP 356 and the curved surface 350S of the subject 350. Accordingly, circularly polarized light enters the object from the QWP 356. The circularly polarized light incident to the object may be right-circular light or left-circular light. The QWP 356 may be the QWP 325 of FIG. 32. The detector 358 is arranged on a location where light emitted from the object is detected. Light emitted from the object enters the detector 358 through the QWP 356.

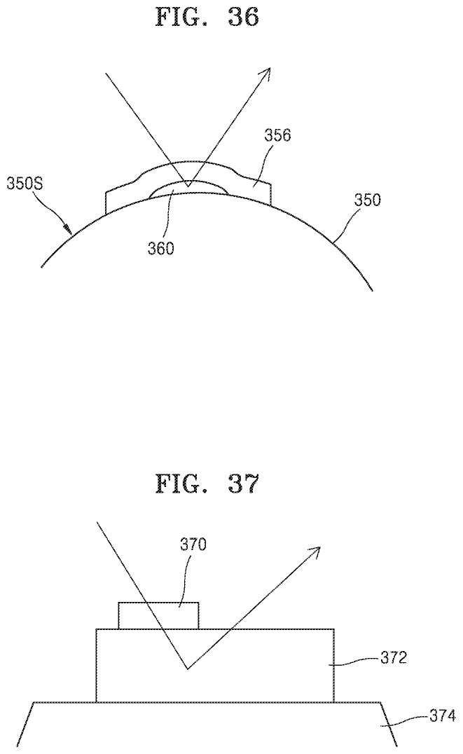

FIG. 36 is a magnified cross-section of a first region B1 of FIG. 35.

Referring to FIG. 36, an object 360 is positioned on the curved surface 350S of the subject 350. The QWP 356 covers the entire object 360.

In the second through fourth detection apparatuses AP2 through AP4, light incident to the objects 322a and 360 through the QWPs 325, 332, and 356 is emitted through the QWP 325, 332, and 356. As depicted in FIG. 37, a QWP 370 covers a portion of an object 372 on a side of a subject 374, and light emitted from the object 372 may enter a detector without passing through the QWP 370.

The QWPs according to the example embodiments described above have flexibility. Accordingly, when the QWPs may be applied to a detection apparatus, the QWPs may be attached to a flat surface or a curved surface. Accordingly, when the QWPs according to the example embodiments are used, the existence of an object attached to a flat surface or a curved surface, for example, a desired material in a biomaterial, for example, a biomaterial having chirality may be detected, and also, the quantification of the material is possible. As a result, when the QWPs according to the example embodiments are used, the application fields of the QWPs are much increased than a QWP of the related art.

The detection apparatuses according to the example embodiments may be used as a detection apparatus based on a ROA method or a detection apparatus based on a VCD method.

While example embodiments have been described with reference to the figures, it will be understood by those of ordinary skill in the art that various changes in form and details may be made therein without departing from the spirit and scope as defined by the following claims.

What is claimed is:

1. A quarter wave plate comprising:
a transparent substrate; and
a plurality of meta-patterns provided on the transparent substrate,
wherein the plurality of meta-patterns are configured to convert linearly polarized light incident thereon into circularly polarized light.

2. The quarter wave plate of claim 1, wherein the transparent substrate is flexible.

3. The quarter wave plate of claim 1, wherein the transparent substrate is inflexible.

4. The quarter wave plate of claim 1, wherein the plurality of meta-patterns comprise horizontally and vertically repeating unit meta-patterns.

5. The quarter wave plate of claim 1, wherein the transparent substrate comprises horizontally and vertically repeating unit regions, and two meta-patterns that are different from each other are provided in each of the unit regions.

6. The quarter wave plate of claim 1, wherein the plurality of meta-patterns are coated with a protection film.

7. The quarter wave plate of claim 4, wherein each of the unit meta-patterns comprises:
a first meta-pattern; and
a second meta-pattern that is perpendicular to and separated from the first meta-pattern.

8. The quarter wave plate of claim 7, wherein the first meta-pattern and the second meta-pattern are embossed.

9. The quarter wave plate of claim 7, wherein a meta-material layer is provided on the transparent substrate,
the first meta-pattern is a first hole formed in the meta-material layer, and
the second meta-pattern is a second hole formed in the meta-material layer.

10. The quarter wave plate of claim 1, wherein a wavelength band of the linearly polarized light comprises light in a range from visible light to near infrared band light.

11. The quarter wave plate of claim 1, wherein a wavelength band of the linearly polarized light comprises infrared band light.

12. The quarter wave plate of claim 6, wherein the protection film comprises an oxide or a nitride.

13. A detection apparatus comprising:
a light source configured to emit linearly polarized light;
a quarter meta-wavelength plate configured to convert the linearly polarized light emitted from the light source and incident thereon into circularly polarized light emitted toward an object; and
a detector configured to detect light incident on the detector from the object that is irradiated with the circularly polarized light from the quarter meta-wavelength plate.

14. The detection apparatus of claim 13, wherein the light source comprises:
a light emitter configured to emit unpolarized light; and
a polarizer configured to convert the unpolarized light into linearly polarized light.

15. The detection apparatus of claim 13, wherein the quarter meta-wavelength plate is flexible.

16. The detection apparatus of claim 13, wherein light emitted from the object passes the quarter meta-wavelength plate.

17. The detection apparatus of claim 13, wherein light emitted from the object does not pass the quarter meta-wavelength plate.

18. The detection apparatus of claim 13, wherein the quarter meta-wavelength plate comprises:
a first meta-pattern; and
a second meta-pattern that is perpendicular to and separated from the first meta-pattern,
wherein the first meta-pattern and the second meta-pattern directly contact the object.

19. The detection apparatus of claim 13, wherein the quarter meta-wavelength plate is a single-use wavelength plate.

20. The detection apparatus of claim 18, wherein the first meta-pattern and the second meta-pattern are coated with a protection film.
